(19) United States
(12) Patent Application Publication
(10) Pub. No.: US 2010/0081534 A1
(43) Pub. Date: Apr. 1, 2010

(54) FRICTIONAL PLANETARY GEAR WITH VARIATOR ACTION

(75) Inventor: Seppo Kanervo, Järvenpää (FI)

Correspondence Address: OSTROLENK FABER GERB & SOFFEN, 1180 AVENUE OF THE AMERICAS, NEW YORK, NY, 100368403, US

(73) Assignee: BEARING DRIVE FINLAND OY, Vaasa (FI)

(21) Appl. No.: 12/514,648

(22) PCT Filed: Nov. 13, 2007
(86) PCT No.: PCT/FI2007/050609

§ 371 Date: Oct. 26, 2009

(30) Foreign Application Priority Data
Nov. 13, 2006 (FI) 20065720

(51) Int. Cl. F16H 13/06

(52) U.S. Cl. 475/183

(57) ABSTRACT

The invention relates to a frictional planetary gear with variator action. A first set of planet wheels roll along the internal rolling surface of a driving ring. A second set of planet wheels roll along a fixed rotation roller path. The planet wheels have pins thereof supported on planet flanges. The planet wheels of the second set are supported by means of a resilient central element for radial displacement. The fixed rotation roller path has a diameter which is adjustable, enabling an easy and expedient regulation of the transmission ratio even at high transmission ratios.

The invention relates to a frictional planetary gear with variator action, which includes
a body
a driving ring
a first set of planet wheels driven by the driving ring
a fixed rotation roller path integrally associated with the body
a second set of planet wheels, rolling along the fixed rotation roller path
pins for the planet wheels, and
a bogie or a planet flange, having the pins of the planet wheels supported thereon.

This type of planetary gear is known from U.S. Pat. No. 5,704,864. In that reference, the planet wheels of first and second sets are diametrally unequal, adjacent tooth rings. This toothed planetary gear does not provide a variator action that would enable a change of the transmission ratio.

JP-10246173 discloses a two-step planetary gear, wherein the driving ring of a higher-speed step is actuated by a variable-speed motor, which is used for eliminating the speed fluctuation of a generator in windmill operation.

It is an object of the invention to provide a frictional planetary gear of the above type, providing a variator action and having its transmission ratio quickly and easily adjusted even at high transmission ratios.

This object is achieved by the invention in such a way that the planet wheels of the second set are supported by means of a resilient central element for radial displacement and that the fixed rotation roller path has a diameter which is adjustable.

The fixed rotation roller path has a diameter which is initially slightly smaller or larger than that of the driving ring. This diametral ratio is adjustable for changing the transmission ratio.

Two exemplary embodiments of the invention will now be described more closely with reference to the accompanying drawings, in which

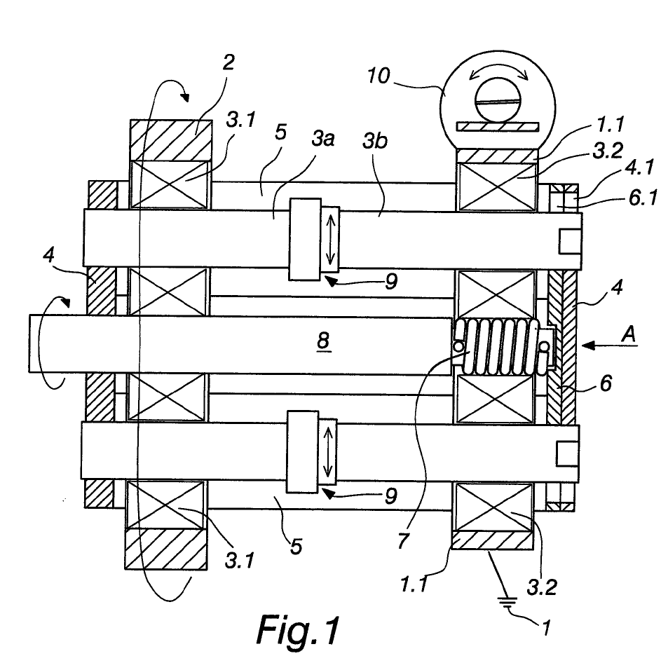

FIG. 1 shows a planetary gear of the invention in an axial section; and

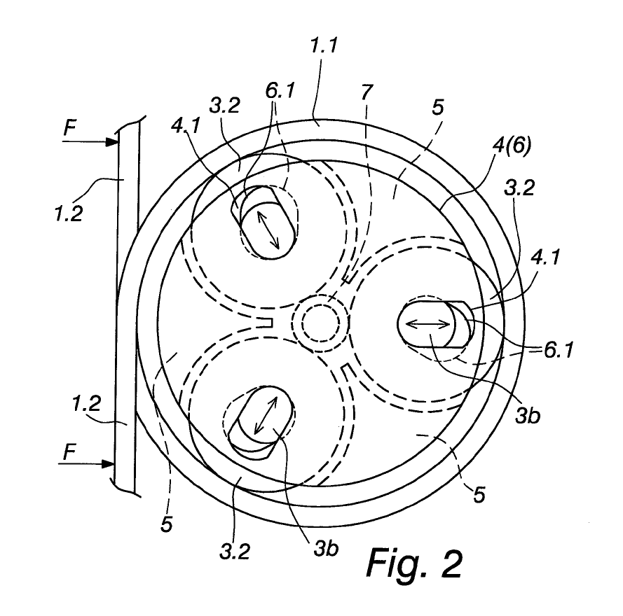

FIG. 2 shows a planetary gear from direction A, which is otherwise similar to that of FIG. 1 except that a clamping band 10 has been replaced with a tightenable spring band, which at the same time establishes a fixed rotation roller path 1.1.

FIGS. 1 and 2 illustrate a frictional planetary gear with variator action. A body 1 features a fixed rotation roller path 1.1, which in the present case is a flat band whose diameter is variable by means of an adjusting device 10. The adjusting device 10 may apply the same principle as hose clamps.

A driving ring 2 is spaced by an axial distance from the rotation roller path 1.1. The rotation roller path 1.1 and the driving ring 2 are concentrical and one is initially slightly smaller or larger than the other. As will become apparent hereinafter, an adjustment of the diametral ratio between the rotation roller path 1.1 and the driving ring 2 enables a change of the transmission ratio.

The driving ring 2 rotates a first set of planet wheels 3.1, which are bearing-mounted for rotation on pins 3a. A second set of planet wheels 3.2 roll along the fixed rotation roller path 1.1 and are bearing-mounted for rotation on pins 3b. The pins 3a and 3b are interconnected at the ends thereof by a sleeve 9, which allows for a radial displacement of the pin 3b relative to the pin 3a. The pins 3 and 3a, 3b are supported on planet flanges 4 present at the opposite ends of a bogie 4, 5. The planet flanges 4 are secured to each other by braces 5 fitted in spaces between the planet wheels 3.1, 3.2, as depicted in FIG. 2. Thus, the planet flanges 4 present at the ends and the braces 5 establish jointly a bogie, revolving around a central shaft 8 at a speed determined by the transmission ratio or the diametral difference between the rings 1.1 and 2.

In view of changing the transmission ratio by adjusting the diameter of the rotation roller path 1.1, the planet wheels 3.2 are supported by means of a central resilient element 7 for a radial displacement. Respectively, the ends of the pins 3b are also supported on the planet flange 4 for a radial displacement. In addition, the pins 3b of the planet wheels 3.2 are interconnected by a mechanism, which compels the radial movement of the planet wheels 3.2 to occur simultaneously and to equal extent. In the illustrated case, this mechanism is provided by a disk 6, featuring slots or elongated holes 6.1, which are set at an acute angle relative to the radial direction and which receive the planet wheel pins 3b and which compel the planet wheels 3.2 to move synchronically to the same extent as the disk 6 rotates relative to the planet flange 4. If necessary, a respective mechanism can be provided at the ends of the pins 3b adjacent to the sleeves 9. Other mechanisms, such as mechanically interconnected eccentric shifters or controllers, may also be feasible.

The pins 3a can also be provided with a similar, short radial displacement allowance to compensate for wearing. The bogie 4, 5 has generally a sufficient rotating speed for the planet wheels 3.1 to squeeze against the internal rolling surface of the driving ring 2 with a force adequate for shifting the moment. The same applies also to the planet wheels 3.2, which squeeze with a centrifugal force against the rotation roller path 1.1, whereby the only function remaining for the spring 7 is to provide a sufficient pre-tensioning even at low rotating speeds.

In the illustrated embodiment, both sets of planet wheels 3.1 and 3.2 have a sun wheel established by the central shaft 8. Accordingly, the resilient element 7 can be configured as a cylindrical spring, especially a coil spring surrounding the sun wheel 8, the diameter of said cylindrical surface being able to diminish against the spring force as the diameter of the rotation roller path 1.1 is being reduced. The spring 7 is preferably supported at one or both of its ends for a free movement in one circumferential direction of the sun wheel 8, while movement in the other direction is denied. What results by virtue of this is a self-clamping effect, i.e. the higher the moment to be transmitted, the more tightly the spring 7 squeezes against the planet wheels 3.2. The ends of the spring 7 may collide with pins present on the shaft 8, which allow for a compression of the spring 7 to its minimum diameter before both ends of the spring make contact with the pins. Alternatively, the spring is provided with a hook at one or both ends, which grasps/grasp recesses present on the shaft 8, one or both of which can be elongated in circumferential direction.

The sun wheel 8 can be freely rotating without a power takeoff in the event that the generator is built in a direct communication with the planetary gear, such that the permanent magnets of the generator's rotor are mounted on the rotary bogie 4, 5 and the stator is built around the latter. Naturally, the power takeoff can also be effected by means of the sun wheel's 8 shaft. Operation of the planetary gear may also proceed in a reversed manner, such that the sun wheel's 8 shaft is a driving shaft and the rotary ring 2 is a driven ring.

FIG. 2 illustrates an alternative solution for a fixed rotation roller path 1.1. It has been constructed from a spiral-coil shaped spring, having its oppositely protruding ends 1.2 supported by forces (power units) working in the direction of arrows F, such that the diameter of the spring coil can be varied by fluctuating the force F. The forces F can also be attractive forces pulling the ends 1.2 in opposite directions.

In the event that the rotation roller path 1.1 and the driving ring 2 have equal diameters, the transmission ratio will be infinite and the driving ring 2 cannot be rotated. Changing the diametral ratio e.g. by about 10% enables, depending on the construction and design, the transmission ratio to be regulated over a very extensive range, such that at its lowest the transmission ratio will be e.g. 4:1. Typically, however, the transmission ratio will be higher than 20. Such a wide-range regulation of transmission ratio is preferably useful in wind-power plant application. When the rotor of a wind power plant has its vanes 13 attached to the driving ring 2, the rotating speed of the vanes can be controlled effectively by changing the transmission ratio of the gear. An increase of the transmission ratio can be used directly for braking the rotation of the vanes and, e.g. in a storm, the vanes can be even stopped by increasing the transmission ratio to a very high value, which is effected by diminishing the diametral difference between the rings 1.1 and 2. This can be effected by having the adjusting device 10 or the forces F controlled by the rotating speed of the vanes.

A shift of the moment between the planet wheels 3.1 and the ring 2 is effected by friction, which is the case also between the planet wheels 3.2 and the ring 1.1 as well as the external surface of the spring 7.

1. A frictional planetary gear with variator action, which includes
a body
a rotary ring
a first set of planet wheels, rolling along an internal rolling surface of the rotary ring
a fixed rotation roller path integrally associated with the body
a second set of planet wheels, rolling along the fixed rotation roller path, which has a diameter which is adjustable for radial displacement of the planet wheels of the second set
pins for the planet wheels, and
a bogie or a planet flange, having the pins of the planet wheels supported thereon,
wherein the planet wheels of the second set are supported by means of a cylindrical surface of a resilient central element for radial displacement as the diameter of said cylindrical surface is able to change.

2. A planetary gear as set forth in claim 1, wherein the fixed rotation roller path has a diameter which is initially slightly smaller or larger than that of the rotating ring and that this diametral ratio is adjustable for changing the transmission ratio.

3. A planetary gear as set forth in claim 1, wherein the pins of the second set of planet wheels are supported on the bogie or planet flange for radial displacement.

4. A planetary gear as set forth in claim 1, wherein both sets of planet wheels have a sun wheel in the form of a central shaft, and that said resilient element is a cylindrical spring, such as a coil spring, surrounding the sun wheel and having the diameter of its cylindrical surface reducible against the spring force by reducing the diameter of the fixed rotation roller path.

5. A planetary gear as set forth in claim 4, wherein the spring is supported at one or both of its ends for a free movement in one circumferential direction of the sun wheel, while movement in the other direction is denied.

6. A planetary gear as set forth in claim 1, wherein the rotary ring is a driving ring.

7. A planetary gear as set forth in claim 1, wherein the vanes of a wind power plant are attached to the rotary ring.

8. A planetary gear as set forth in claim 7, wherein the fixed rotation roller path has its diameter adjustable by means of a regulating device receiving its control from the rotational speed of the vanes of a wind power plant.

9. A method for operating a planetary gear as set forth in claim 7, wherein the rotational speed of the vanes of a wind power plant is limited by reducing the difference between the diameters of the rotary ring and the fixed rotation roller path.
